(19) United States
(12) Patent Application Publication
(10) Pub. No.: US 2026/0045792 A1
(43) Pub. Date: Feb. 12, 2026

(54) MICROGRID HEALTH DETECTION

(71) Applicant: Caterpillar Inc., Peoria, IL (US)

(72) Inventors: Sowmya NAGESH, Peoria, IL (US); Gregory Scott HASLER, Pekin, IL (US); Ronald Christopher GAYLES, Peoria, IL (US); Ranjay SINGH, Kanpur (IN); Manoj Kumar BANTUPALLI, Vizianagaram (IN); Srideep CHATTERJEE, Bhopal (IN)

(73) Assignee: Caterpillar Inc., Peoria, IL (US)

(21) Appl. No.: 18/796,850

(22) Filed: Aug. 7, 2024

(51) Int. Cl. H02J 3/00; H02J 3/32; H02J 3/38; H02J 7/00

(52) U.S. Cl. CPC H02J 3/0012; H02J 3/32; H02J 3/381; H02J 7/0048; H02J 2203/10; H02J 2300/10

(57) ABSTRACT

A microgrid controller of a microgrid configured to receive load information corresponding to a plurality of loads connected to the microgrid, receive energy resource information corresponding to a plurality of energy resource systems connected to the microgrid monitor one or more microgrid parameters, according to a soft diagnostic condition, based on at least one of the energy resource information or the load information, detect a soft trigger event based on the one or more microgrid parameters satisfying the soft diagnostic condition, in response to the soft diagnostic condition being satisfied, monitor the one or more microgrid parameters, according to a hard diagnostic condition, based on at least one of the energy resource information or the load information, detect a hard trigger event based on the one or more microgrid parameters satisfying the hard diagnostic condition, and in response to the hard diagnostic condition being satisfied, generate a hard alarm.

### TECHNICAL FIELD

The present disclosure relates generally to microgrids and, for example, to a microgrid controller configured to control or manage an operation of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors, etc.), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode, for example, based on a schedule or based on one or more conditions being satisfied.

China patent application CN115189476A discloses an intelligent operation and maintenance control system and method for an unattended microgrid, which comprises the following steps: the information acquisition module is used for acquiring and recording the running state information of the micro-grid in real time, sending alarm information when the running state of the micro-grid changes, and receiving and executing the control operation of the intelligent sequential control module; the fault judging module is used for judging whether the micro-grid has a fault or not, and if the micro-grid has the fault, identifying a fault element of the micro-grid and generating a fault judging result; the system analysis decision module is used for selecting matched fault treatment measures from the microgrid strategy table; the intelligent sequence control module is used for generating multi-step control operation which can be continuously executed according to the fault treatment measures; and the remote management module is used for remotely managing the operation state of the micro-grid, the micro-grid strategy table and the operation steps of the intelligent sequence control module. The China patent application discloses that the maintenance control system and method can realize the operation and maintenance control of the micro-grid under the unattended condition and enlarge the social benefit and the economic benefit of the micro-grid.

However, the China patent application does not disclose raising diagnostics for failed microgrid assets, such as failed DERs, raising diagnostics when an asset is in a critical stage of failure, or predicting, based on functional safety feedback on asset feedback, and, based on real time data, if a current mode of operation of the microgrid may fail, and taking one or more corrective actions (e.g., changing the mode of operation) based on predicted or detected failure.

The microgrid controller of the present disclosure solves one or more of the problems set forth above and/or other problems in the art.

### SUMMARY

A microgrid controller of a microgrid may include one or more memories configured to store a health monitoring algorithm; a communication interface configured to receive load information corresponding to a plurality of loads connected to the microgrid, receive energy resource information corresponding to a plurality of energy resource systems connected to the microgrid, and generate one or more alarms based on the health monitoring algorithm; and one or more processors, coupled to the one or more memories for executing the health monitoring algorithm, wherein the one or more processors are configured to: monitor one or more microgrid parameters, according to a soft diagnostic condition, based on at least one of the energy resource information or the load information, detect a soft trigger event based on the one or more microgrid parameters satisfying the soft diagnostic condition, in response to the soft diagnostic condition being satisfied, monitor the one or more microgrid parameters, according to a hard diagnostic condition, based on at least one of the energy resource information or the load information, detect a hard trigger event based on the one or more microgrid parameters satisfying the hard diagnostic condition, and in response to the hard diagnostic condition being satisfied, generate a hard alarm.

A method of monitoring for errors within a microgrid may include receiving, by a microgrid controller, energy resource information corresponding to a plurality of energy resource systems associated with the microgrid; receiving, by the microgrid controller, load information corresponding to a plurality of loads associated with the microgrid; monitoring, by the microgrid controller, one or more microgrid parameters, according to a soft diagnostic condition, based on at least one of the energy resource information or the load information; detecting, by the microgrid controller, a soft trigger event based on the one or more microgrid parameters satisfying the soft diagnostic condition; in response to the soft diagnostic condition being satisfied, monitoring, by the microgrid controller, the one or more microgrid parameters, according to a hard diagnostic condition, based on at least one of the energy resource information or the load information; detecting, by the microgrid controller, a hard trigger event based on the one or more microgrid parameters satisfying the hard diagnostic condition; and in response to the hard diagnostic condition being satisfied, generating, by the microgrid controller, a hard alarm.

### BRIEF DESCRIPTION OF THE DRAWINGS

FIG. 1 shows a system according to one or more implementations.

FIG. 2 shows a microgrid according to one or more implementations.

FIG. 3 shows an example of a transition from an implicit check to an explicit check.

FIG. 4 is a flowchart of an example process associated with improved microgrid health detection.

FIG. 5 is a diagram of example components of the microgrid controller associated with improved microgrid health detection.

### DETAILED DESCRIPTION

This disclosure relates to a power distribution system, and is applicable to any system that distributes and/or receives power via a power grid. Some aspects relate to a microgrid controller that is configured to control one or more components and/or systems associated with the microgrid, including energy resource systems (e.g., DERs) and/or loads. The microgrid controller may control a state of the microgrid based on one or more conditions being satisfied. Additionally, the microgrid controller may monitor and assess a health of the microgrid. For example, the microgrid controller may monitor one or more operational conditions, detect or predict one or more errors (e.g., faults) of the microgrid, raise one or more alarms based on the detected or predicted errors, and, in some cases, take one or more corrective actions based on the based on the detected or predicted errors. An error may be an error associated with a mode of operation of the microgrid, an error associated with one or more loads of the microgrid, an error associated with one or more DERs of the microgrid, an error associated with one or more components of the microgrid (e.g., power bus, communication interface, inverter, switch, or distribution breaker), or any combination thereof.

The microgrid controller may provide three layers for microgrid health diagnostics to enable flexibility to an operator to prognosticate system health and power producing asset capability or availability. A first layer may include an inflexible category that includes diagnostics related to functional safety, which are on each microgrid asset. A second layer may include a first flexible category that includes diagnostics, which detect failures, such as mode transition failures, failures to close distribution breakers, or one or more DERs being unavailable for operation (e.g., failure to start). A second layer may include a second flexible category of conditional diagnostics that prognosticate failures based on math or calculations of active (real) or reactive power based on modes of operation, which may be selected by the operator. The conditional diagnostics may be acknowledged and implicitly cleared by the microgrid controller.

The microgrid controller may provide a flexible methodology to diagnose failures in microgrids in the three layers. For example, the microgrid controller may employ a flexible, implicit, and explicit approach to detect microgrid health parameters which may aid in operator optimization of a power distribution scheme and overall performance of the microgrid. The microgrid controller may perform conditional diagnostics for detecting one or more faults in the microgrid. An explicit check (e.g., a hard diagnostic) is a category of conditional diagnostics that may be customized and tied to message annunciations, flashing alarms, piezo alarms, or implicit checks in each category that can be indicated based on customer or site requirements. An explicit check may result in a hard fault being detected based on one or more hard conditions being satisfied.

An implicit check (e.g., a soft diagnostic) is a category of conditional diagnostics that may be transitioned by the microgrid controller to an explicit check upon one or more soft conditions being satisfied. Thus, an implicit check may be paired with an explicit check. A soft condition may be based on a value threshold, a time threshold, an occurrence frequency threshold, a cumulative count threshold, or any combination thereof. An implicit check may be cleared by the microgrid controller after a certain operational condition set by the operator is satisfied. For example, an implicit check may be cleared after a certain time period lapses without triggering a corresponding explicit check, or after a certain value threshold is detected that clears the soft condition. For example, a same threshold used to trigger the soft condition may be used to clear the soft condition (e.g., resulting in a reversal condition). The implicit check may be used as a prognostic to a hard diagnostic.

A microgrid health detection scheme employed by the microgrid controller may be entirely customizable, communication protocol agnostic, and detectable to aid in service. The microgrid health detection scheme may be cumulatively logged and trends accumulated for overall power performance of microgrid site. The microgrid health detection scheme may be cumulatively logged and trends accumulated for overall effectiveness of optimization strategies such as for a load smoothing mode or a scheduler mode, which can be configured differently based on behaviors.

A method for evaluating health of a microgrid may include evaluating a first diagnostic category that includes diagnostics related to functional safety, evaluating a second diagnostic category that includes diagnostics which detect failures (such as, but not limited to, mode transition failures, failure to close breakers, or an unavailability of one or more DERs), and evaluating a third diagnostic category that prognosticate failures based on math or calculations of active (Real) or reactive power based on modes.

A microgrid controller may monitor one or more microgrid parameters (e.g., health parameters and/or operating parameters), according to a soft diagnostic condition, based on information or received from one or more components associated with the microgrid, detect a soft trigger event based on the one or more microgrid parameters satisfying the soft diagnostic condition, in response to the soft diagnostic condition being satisfied, monitor the one or more microgrid parameters, according to a hard diagnostic condition, based on the information received from the one or more components associated with the microgrid, detect a hard trigger event based on the one or more microgrid parameters satisfying the hard diagnostic condition, and in response to the hard diagnostic condition being satisfied, generate a hard alarm.

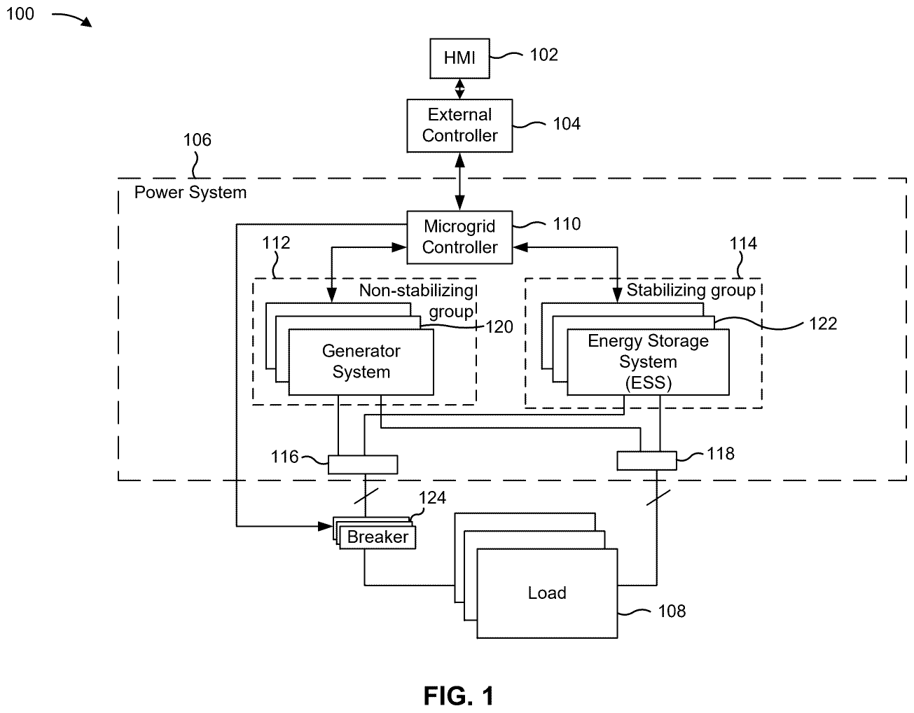

FIG. 1 shows a system 100 according to one or more implementations. The system 100 may include a human-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Each local generator controller may control how much power a respective power generator generates, control a rate of power distribution, and/or obtain status information corresponding to the respective power generator. Each local generator controller may be controlled by the microgrid controller 110.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. Each local ESS controller may control a flow of power into or out of a respective electric storage device, including charging of the respective electric storage device and discharging of the respective electric storage device, control a rate of power flow, and/or obtain status information corresponding to the respective electric storage device, parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106. The one or more breakers 124 may be part of one or both interfaces 116 and 118.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user's preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and 118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108. The loads can be active (real) or reactive to allow for a power quality-based approach to scheduling. Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data (e.g., energy resource information). The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source. The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data (e.g., energy resource information) and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions. Reactive and/or active may be used as a qualifier for loads, where reactive loads may contribute to a stabilization algorithm in addition to the active or real loads.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122.

To process the generator data and the energy storage data to generate the ESD instructions, the control application may include a load stabilization function and/or an SOC function. The control application may also include a health monitoring function. The control application may also include a generator set limit function and/or energy store discharge/charge limit function to generate the ESD instruction. In some cases, the load stabilization function may be activated while the power system 106 is configured in stand-alone mode in order to provide off-grid load stabilization. The microgrid controller 110 may automatically activate or deactivate the aforementioned system functions based on presence or absence of systems parameters (such as no generator set minimum threshold value is available, etc.) or one or more system conditions being satisfied.

Generally, the load stabilization function may ensure system bus frequencies of the one or more energy generator systems 120 are maintained at a nominal value by causing an amount of power to be absorbed/injected by the one or more energy storage systems 122. The amount of power may be determined based on a difference from an instantaneous load and a moving average of the load. Meanwhile, the SOC function may ensure the one or more energy storage systems 122 are charged to a target SOC or a target SOC range such that a SOC of one or more energy storage systems does not drift too low or too high, outside of a desired operating range (e.g., the target SOC range). The target SOC or the target SOC range may enable the at least one energy storage system 122 to provide long term beneficial use to the system 100, such as having a range of operation usable by the power system 106 and/or avoid degradation ranges of the one or more energy storage systems 122.

The health monitoring function may ensure that errors or faults are detected such that corrective measures can be taken by the microgrid controller or an operator. For example, the microgrid controller 110 may be configured to execute a health monitoring algorithm for monitoring one or more system parameters that may be used for detecting soft conditions or hard conditions (e.g., soft faults or hard faults) based on conditional diagnostics.

Furthermore, the systems and methods of the present disclosure may check the ESD instruction against acceptable generator maximum/minimum loads of the one or more energy generator systems 120 and the discharge/charge limits of the one or more energy storage systems 122, so as to safely operate the one or more energy generator systems 120.

One or more energy generator systems 120 may include an engine-generator that provides AC power to the power system 106, which may provide the AC power to the at least one load 108. Generally, an engine-generator may be any device that converts motive power (mechanical energy) into electrical power to output the AC power. An engine-generator may be a gas turbine electrical generator. In such gas turbine electrical generators, fast changes in load from the at least one load 108 may cause a system bus frequency to deviate from a nominal value. The system bus frequency may be a frequency of electrical components of the generator. For instance, such gas turbine electrical generators may have isochronous frequency control governors that may try to maintain the system bus frequency to the nominal value in response to changes of the load of the one or more loads 108. Therefore, during a transient load charge (e.g., a load transient), the system bus frequency may change as the load on the engine-generator changes. However, a rate of return of the system bus frequency back to the nominal value is slower than a desired rate due to an inertia of motion of physical components (e.g., a rotor of a stator-rotor) of the engine-generator. The slow rate of return may reduce power quality of the power system 106. The power quality of the power system 106 may be determined based on the voltage, frequency, and waveform of the power output to the one or more loads 108. A high power quality may ensure continuity of service for the one or more loads 108, such that the one or more loads 108 are able to properly function as intended. A low power quality may cause the one or more loads 108 to malfunction, fail prematurely, or not operate at all.

Therefore, avoiding load transients may be beneficial in providing better power quality. However, generally, controlling a load of the one or more loads 108 may not be possible or desirable. Instead, the microgrid controller 110 may control the one or more energy storage systems 122 of the stabilizing group of energy resource systems 114 to act as a power consumer or as an energy source, so that the one or more energy generator systems 120 of the non-stabilizing group of energy resource systems 112 may maintain the system bus frequency at the nominal value, thereby ensuring better power quality.

The microgrid controller 110 may control the one or more energy storage systems 122 to act as a near instantaneous load or energy source, so that the one or more energy generator systems 120 may maintain the system bus frequency at the nominal value, thereby ensuring better power quality. In one aspect of this disclosure, the microgrid controller 110 may control the one or more energy storage systems 122 to instantaneously inject power when power is needed by the at least one load 108 or instantaneously absorb surplus power generated by the one or more energy generator systems 120. Accordingly, the microgrid controller 110 regulates the power supply such that an exact amount of desired power supply flows in or out of the power system 106 at any given time. The instantaneous injecting/absorbing power may be performed to control the amount of transient load seen by the power system 106 and thus stabilize the load and resulting system bus frequency of the one or more energy generator systems 120. The desired power may be calculated by performing a moving average of a system load and then taking a difference of the moving average and an instantaneous load value. This difference may be the desired power output/absorbed of the energy store. Causing the one or more energy storage systems 122 to output/absorb the desired power (e.g., by transmitting the energy storage dispatch instructions) may limit the transient load seen by the one or more energy generator systems 120.

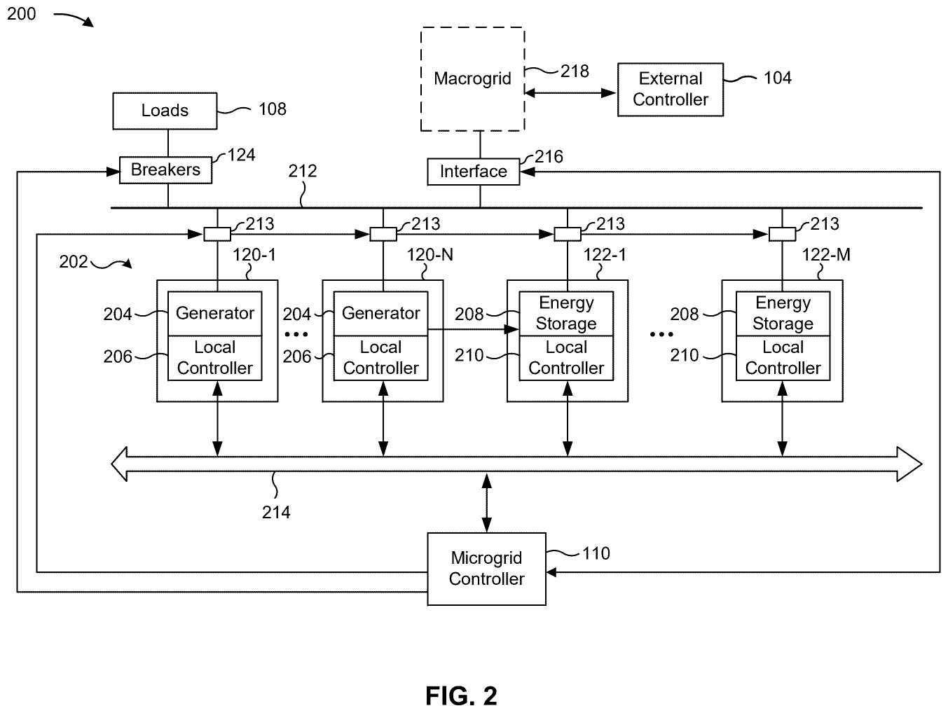

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an N^{th} energy generator system 120-N. Additionally, the plurality of DERs 202 may include a first energy storage system 122-1 and an M^{th} energy storage system 122-M. Each energy generator system 120 may include a power generator 204 and a local generator controller 206. Each energy storage system 122 may include an electric storage device 208 (e.g., one or more batteries and/or capacitors) and a local ESS controller 210.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information from microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information from microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads 108. The one or more loads 108 may be connected to the power bus 212 via one or more breakers 124 to receive power from the power bus. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows in or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads 108 and/or DERs 202.

The microgrid 200 may include an interface 216 for connecting the microgrid 200 to and disconnecting the microgrid 200 from an electrical power distribution system 218, such as a macrogrid. The electrical power distribution system 218 may include the external controller 104 (e.g., a macrogrid controller), as described in connection with FIG. 1. The external controller 104 may be coupled to the interface 216 for transmitting control signals, such as instructions or requests, to the microgrid controller 110. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

The microgrid controller 110 may be configured to, via one or more processors, execute a health monitoring algorithm for monitoring one or more system parameters that may be used for detecting soft conditions or hard conditions (e.g., soft faults or hard faults) based on conditional diagnostics. The microgrid controller 110 may monitor one or more microgrid parameters, according to a soft diagnostic condition, based on at least one of the energy resource information or the load information; detect a soft trigger event based on the one or more microgrid parameters satisfying the soft diagnostic condition, in response to the soft diagnostic condition being satisfied; monitor the one or more microgrid parameters, according to a hard diagnostic condition, based on at least one of the energy resource information or the load information; detect a hard trigger event based on the one or more microgrid parameters satisfying the hard diagnostic condition; and in response to the hard diagnostic condition being satisfied, generate a hard alarm. The microgrid controller 110 may be configured to, in response to the soft diagnostic condition being satisfied, generate a soft alarm.

The soft diagnostic condition may correspond to an implicit check (e.g., implicit diagnostic), whereas the hard diagnostic condition may correspond to an explicit check (e.g., explicit diagnostic). Soft diagnostics may issue a soft alarm when the soft diagnostic condition is satisfied, indicating a soft fault. An operator may choose to act on or ignore a soft alarm. Hard diagnostics may issue a hard alarm when the hard diagnostic condition is satisfied, indicating a hard fault. A hard alarm may indicate that immediate attention or action may be required to avoid a critical component or system failure. Thus, a soft alarm may provide a time delay between a potential fault or predicted fault occurring and a hard alarm, which indicates that a fault has occurred. In other words, monitoring for the soft condition may delay performing and explicit check. Thus, the implicit check may serve as a buffer or a filter for anomalies that occur temporarily may be resolved without intervention before an explicit check is triggered by the microgrid controller 110. Triggering of a diagnostic and any resultant delay between the soft trigger event and the hard trigger event can be based on a certain time delay, a counter delay, a threshold delay, and/or any particular rule set condition that is defined within the microgrid controller 110 (e.g., defined within the health monitoring algorithm), which may be configured by an operator. Multiple soft diagnostic conditions may be monitored in parallel. Similarly, multiple hard diagnostic conditions may be monitored in parallel. In some cases, a soft diagnostic condition of one type may be monitored in parallel with a hard diagnostic condition of another type. Implementations are not limited to a number of diagnostic conditions that can be simultaneously monitored in parallel. Separate circuitry, processors, counters, timers, and/or threshold comparators may be provided for each type of conditional diagnostic.

The soft diagnostic condition may be a fixed setpoint condition. The hard diagnostic condition may be a dynamic setpoint condition. The microgrid controller 110 may adjust the hard diagnostic condition as a function of an operational activity of the microgrid 200. For example, the microgrid controller 110 may adjust the hard diagnostic condition based on a rate-of-change of one of the microgrid parameters or based a magnitude of the microgrid parameter. For example, the microgrid controller 110 may adjust the hard diagnostic condition based on a real-time load rate-of-change (e.g., based on a rate a total load on the microgrid 200 is changing. For example, a high load rate-of-change may result in a difference between a soft condition threshold and a hard condition threshold being decreased, whereas a low load rate-of-change may result in the difference between the soft condition threshold and the hard condition threshold being increased or maintained at a default setting. Thus, the hard diagnostic condition may include a dynamic threshold, and the microgrid controller 110 may adjust the dynamic threshold as a function of the operational activity, such as the real-time load rate-of-change, of the microgrid 200.

The soft diagnostic condition and/or the hard diagnostic condition may include at least one of a value-based threshold or a time-based threshold. For example, the soft diagnostic condition and/or the hard diagnostic condition may be rule-based conditions that include at least one of: a value-based threshold that is satisfied when a microgrid parameter has a magnitude that satisfies the value-based threshold, a time-based threshold that is satisfied when a microgrid parameter satisfies the value-based threshold for a threshold duration, a frequency-based threshold that is satisfied when a microgrid parameter satisfies a condition a threshold number of times within a predetermined time interval, or a cumulative count-based threshold that is satisfied when a microgrid parameter satisfies a condition a threshold number of times.

The plurality of energy resource systems may include a fuel-based energy resource system, such as an engine-generator or a genset. The fuel-based energy resource system may be an energy generator system 120. The microgrid 200 may be configured to operate in a reliability mode or an economy mode. In reliability mode, at least one fuel-based energy resource systems is always on to provide power to the microgrid 200 in order to ensure the microgrid 200 remains powered, for example, to operate one or more loads 108 and/or to export power to the electrical power distribution system 218 (e.g., the macrogrid). In economy mode, all fuel-based energy resource systems may be shut off when certain conditions are met. For example, all fuel-based energy resource systems may be shut off when all active energy storage systems 122 have an SOC above a minimum SOC threshold. During economy mode, one or more fuel-based energy resource systems may be brought online to charge one or more energy storage systems 122. Thus, the fuel-based energy resource systems may be shut off as much as possible.

The one or more microgrid parameters may include an operation mode of the fuel-based energy resource system, including an inactive operation mode and a running operation mode, during which the fuel-based energy resource system generates power. The soft diagnostic condition may be satisfied based on the fuel-based energy resource system failing to transition from the inactive operation mode to the running operation mode within a first time duration that starts at a time a start command may be issued to the fuel-based energy resource system. In other words, the soft diagnostic condition may be satisfied when the fuel-based energy resource system fails to start after a certain amount of time after the microgrid controller issues the start command to the fuel-based energy resource system. The hard diagnostic condition may be satisfied based on the fuel-based energy resource system failing to transition from the inactive operation mode to the running operation mode within a second time duration that starts at a time the soft diagnostic condition is satisfied. For example, the soft trigger event may trigger the second time duration to start. In addition, the plurality of energy resource systems may include a chargeable energy storage system, such as an energy storage system 122. These soft and hard diagnostic conditions may be used to detect failures in the economy mode. The microgrid controller 110 may monitor an SOC of the chargeable energy storage system; compare the SOC to a minimum SOC threshold; and issue the start command to the fuel-based energy resource system based on the SOC being less than the minimum SOC threshold. For example, the fuel-based energy resource system may be triggered to start in order to charge the chargeable energy storage system, in order to increase the SOC of the chargeable energy storage system. However, a failed start of the fuel-based energy resource system may result in the microgrid 200 having insufficient power to supply all current loads 108, which may be further indicative of a failure of the economy mode. Thus, additional DERs may need to be activated (e.g., brought online) or one or more loads may need to be shedded or dropped from the microgrid 200 to avoid a critical failure, such as an overload, of the microgrid 200.

The one or more microgrid parameters may include an operation mode of an energy resource system, including a first operation mode, during which the energy resource system does not supply power to the microgrid, and a second operation mode, during which the energy resource system supplies power to the microgrid. The soft diagnostic condition may be satisfied based on the energy resource system failing to transition between the first operation mode and the second operation mode within a first time duration that starts at a time a mode command may be issued to the energy resource system. The hard diagnostic condition may be satisfied based on the energy resource system failing to transition between the first operation mode and the second operation mode within a second time duration that starts at a time the soft diagnostic condition may be satisfied. The first operation mode may be an off mode and the second operation mode may be an on mode. Thus, the soft diagnostic condition and the hard diagnostic condition may correspond to an energy resource system (e.g., an energy generator system 120 or an energy storage system 122) failing to turn on or off when instructed to.

The microgrid controller 110 may monitor an SOC of the one or more chargeable energy storage systems, and monitor a total load on the microgrid, the total load being cumulative of the plurality of loads 108. The soft diagnostic condition may be satisfied based on the SOC being less than an SOC threshold. The hard diagnostic condition may be satisfied based on the SOC decreasing for a time duration during which the total load is increasing, the time duration starting at a time the soft diagnostic condition is satisfied. Thus, the hard trigger event may be triggered if the SOC continues to be depleted below the SOC threshold while loads are being added to the microgrid 200, which may result in the microgrid 200 having insufficient power to supply all current loads 108. Thus, additional DERs may need to be activated (e.g., brought online) or one or more loads may need to be shedded or dropped from the microgrid 200 to avoid a critical failure, such as an overload, of the microgrid 200. Thus, the microgrid controller 110 may perform SOC and load step-up monitoring to prevent a system overload.

Alternatively, the soft diagnostic condition may be satisfied based on the SOC decreasing, for a first time duration, while the total load is increasing, and the hard diagnostic condition may be satisfied based on the SOC decreasing, for a second time duration that starts at a time the soft diagnostic condition is satisfied, while the total load is increasing.

Alternatively, the soft diagnostic condition may be satisfied based on the SOC being less than an SOC threshold, and the hard diagnostic condition may be satisfied based on the SOC decreasing for a time duration that starts at a time the soft diagnostic condition is satisfied.

Alternatively, the soft diagnostic condition may be satisfied based on the SOC being less than a first SOC threshold, and the hard diagnostic condition may be satisfied based on the SOC being less than a second SOC threshold while the total load is increasing. The second SOC threshold may be less than the first SOC threshold.

The microgrid controller 110 may be configured to stop the total load from increasing based on the hard diagnostic condition being satisfied. For example, the microgrid controller 110 may be configured to, in response to the hard trigger event being triggered, automatically shed one or more loads from the microgrid 200 to stop the total load from increasing and to prevent the critical failure of the microgrid 200. In some implementations, the loads 108 may be prioritized based on a tiered priority scheme, and the microgrid controller 110 may be configured to, in response to the hard trigger event being triggered, automatically shed one or more lower-priority loads from the microgrid 200 to stop the total load from increasing and to prevent the critical failure of the microgrid 200. The microgrid controller 110 may be configured to prioritize the loads 108 based on an algorithm, load information, and/or a dispatch schedule.

The microgrid controller 110 may monitor an output power of one or more energy resource systems based on a target output power. The soft diagnostic condition may be satisfied based on the output power being less than the target output power for a first time duration. The hard diagnostic condition may be satisfied based on the output power being less than the target output power for a second time duration that starts at a time the soft diagnostic condition is satisfied. Thus, the hard trigger event may be triggered if there is a mismatch between the output power being supplied to the microgrid 200 and a power requirement (e.g., to operate all loads and/or be exported to the electrical power distribution system 218), which may result in the microgrid 200 having insufficient power to supply all required loads. This type of error may be referred to as an asset dispatch error. Thus, additional DERs may need to be activated (e.g., brought online) or one or more loads may need to be shedded or dropped from the microgrid 200 to avoid a critical failure, such as an overload, of the microgrid 200.

The microgrid controller 110 may dispatch power from the generator system (e.g., an energy generator system 120) to charge the chargeable energy storage system (e.g., an energy storage system 122), and monitor an amount of power provided by the generator system to the chargeable energy storage system relative to a target amount of power. The soft diagnostic condition may be satisfied based on the amount of power being less than the target amount of power for a first time duration. The hard diagnostic condition may be satisfied based on the amount of power being less than the target amount of power for a second time duration that starts at a time the soft diagnostic condition is satisfied. Thus, the soft diagnostic condition and the hard diagnostic condition may be triggered when the generator system fails to provide sufficient power to the chargeable energy storage system to adequately charge the chargeable energy storage system, which may be needed for an upcoming scheduled operation or an anticipated load increase. This type of error may be referred to as an asset dispatch error. Thus, additional DERs may need to be activated (e.g., brought online) or one or more loads may need to be shedded or dropped from the microgrid 200 to avoid a critical failure, such as an overload, of the microgrid 200.

The microgrid controller 110 may monitor an output power of one or more energy resource systems based on a target output power. The soft diagnostic condition may be satisfied based on the output power changing by at least a threshold amount a first threshold number of times within a first time interval. In other words, the output power may toggle a certain number of times within a time period that is indicative of a soft fault. The hard diagnostic condition may be satisfied based on the output power changing by at least the threshold amount a second threshold number of times within a second time interval. In other words, the output power may continue to toggle a certain number of times within a time period that is indicative of a hard fault. This type of error may be referred to as an asset toggling error.

The microgrid controller 110 may monitor an amount of power imported from the electrical power distribution system 218 relative to a target import power. The soft diagnostic condition may be satisfied based on the amount of power being less than the target import power for a first time duration or being less than the target import power by at least a first threshold amount, indicating a possible import error, which may result in insufficient power to operate loads 108. The hard diagnostic condition may be satisfied based on the amount of power being less than the target import power for a second time duration or being less than the target import power by at least a second threshold amount, indicating an import error. The second time duration may start at a time the soft diagnostic condition is satisfied. The second threshold amount may be equal to or greater than the first threshold amount. In some cases, the amount of power may be real power or reactive power.

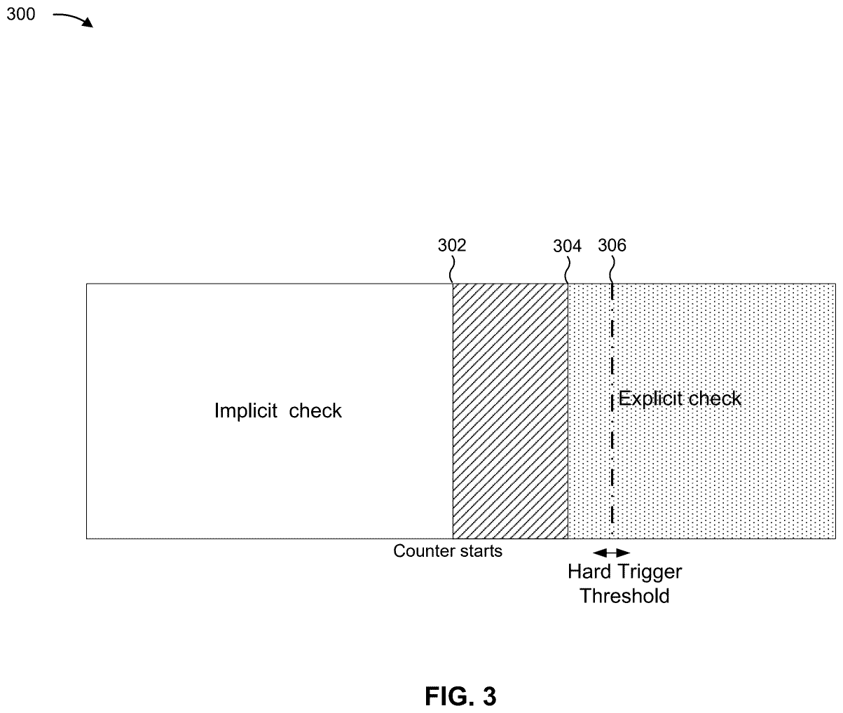

FIG. 3 shows an example 300 of a transition from an implicit check to an explicit check. During an implicit check, the microgrid controller 110 may monitor for a soft diagnostic condition. The soft diagnostic condition may include a value-based threshold 302 and a time-based threshold 304. For example, the value-based threshold 302 may trigger a counter. The time-based threshold 304 may trigger a soft trigger event when the counter satisfies the time-based threshold 304. During the explicit check, the microgrid controller 110 may monitor for a hard diagnostic condition. The hard diagnostic condition may include a threshold 306, which may be a value-based threshold, a time-based threshold, or a combination thereof. The threshold 306 may be a dynamic threshold that varies as a function of an operational activity of the microgrid 200. The threshold 306 may trigger a hard trigger event when the threshold 306 is satisfied.

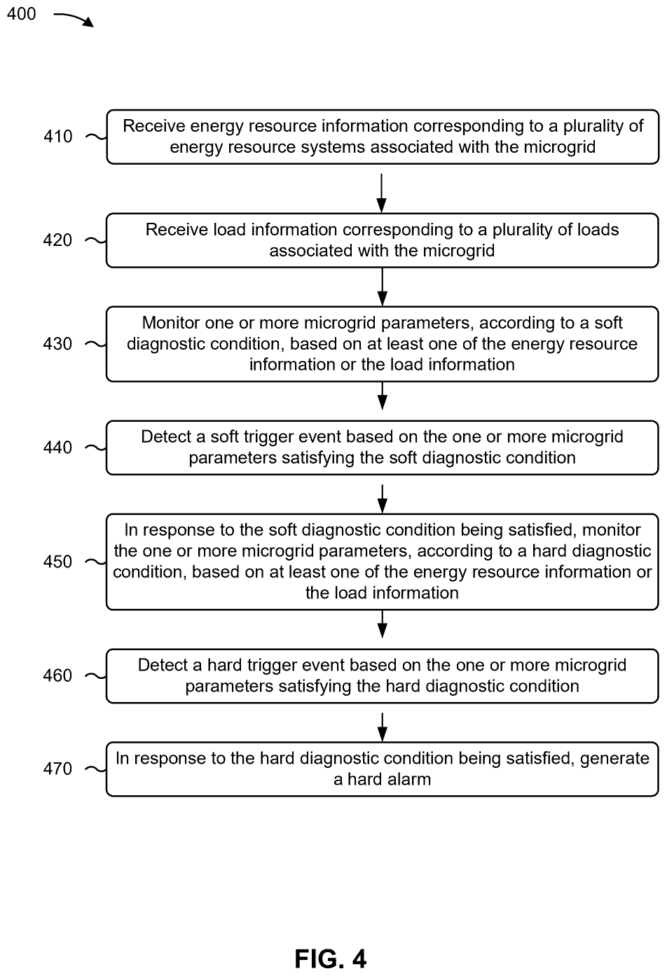

FIG. 4 is a flowchart of an example process 400 associated with improved microgrid health detection. One or more process blocks of FIG. 4 may be performed by a microgrid controller (e.g., microgrid controller 110). Additionally, or alternatively, one or more process blocks of FIG. 4 may be performed by another device or a group of devices separate from or including the microgrid controller, such as another device or component that is internal or external to microgrid 200.

As shown in FIG. 4, process 400 may include receiving energy resource information corresponding to a plurality of energy resource systems associated with the microgrid (block 410). For example, the microgrid controller 110 may receive energy resource information corresponding to a plurality of energy resource systems associated with a microgrid, as described above.

As further shown in FIG. 4, process 400 may include receiving load information corresponding to a plurality of loads associated with the microgrid (block 420). For example, the microgrid controller 110 may receive load information corresponding to a plurality of loads associated with the microgrid, as described above.

As further shown in FIG. 4, process 400 may include monitoring one or more microgrid parameters, according to a soft diagnostic condition, based on at least one of the energy resource information or the load information (block 430). For example, the microgrid controller 110 may monitor one or more microgrid parameters, according to a soft diagnostic condition, based on at least one of the energy resource information or the load information, as described above.

As further shown in FIG. 4, process 400 may include detecting a soft trigger event based on the one or more microgrid parameters satisfying the soft diagnostic condition (block 440). For example, the microgrid controller 110 may detect a soft trigger event based on the one or more microgrid parameters satisfying the soft diagnostic condition, as described above.

As further shown in FIG. 4, process 400 may include monitoring the one or more microgrid parameters, according to a hard diagnostic condition, based on at least one of the energy resource information or the load information (block 450). For example, the microgrid controller 110 may monitor the one or more microgrid parameters, according to a hard diagnostic condition, based on at least one of the energy resource information or the load information, as described above.

As further shown in FIG. 4, process 400 may include detecting a hard trigger event based on the one or more microgrid parameters satisfying the hard diagnostic condition (block 460). For example, the microgrid controller 110 may detect a hard trigger event based on the one or more microgrid parameters satisfying the hard diagnostic condition, as described above.

As further shown in FIG. 4, process 400 may include generating a hard alarm (block 470). For example, the microgrid controller 110 may generate a hard alarm, as described above.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

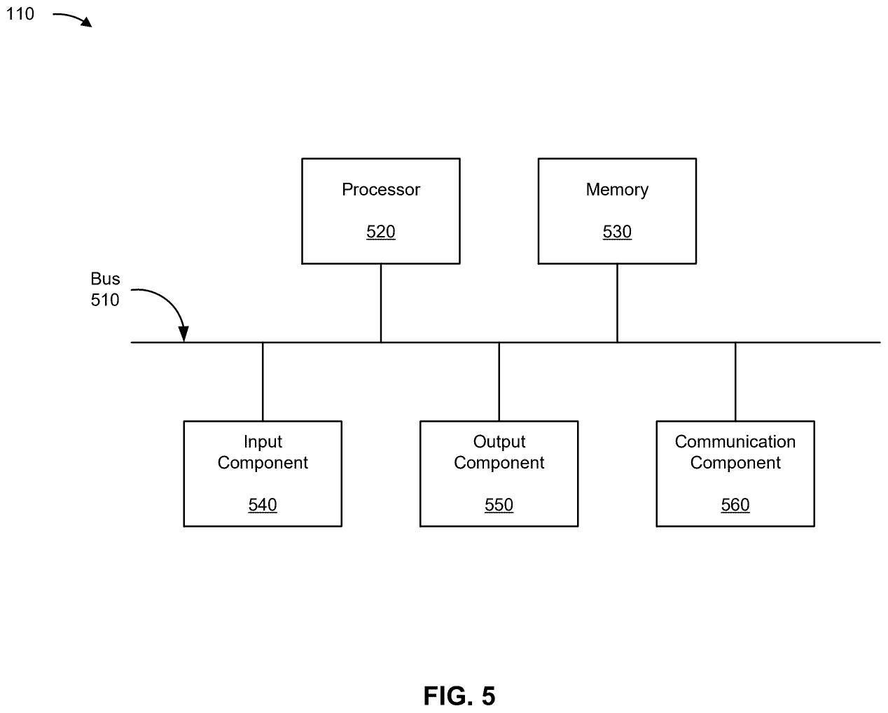

FIG. 5 is a diagram of example components of the microgrid controller 110 associated with improved microgrid health detection. The microgrid controller 110 may include a bus 510, a processor 520, a memory 530, an input component 540, an output component 550, and/or a communication component 560.

The bus 510 may include one or more components that enable wired and/or wireless communication among the components of the microgrid controller 110. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus.

The processor 520 may include a central processing unit a microprocessor, a controller, a microcontroller, a digital signal processor, a field-programmable gate array, an application-specific integrated circuit, and/or another type of processing component. The processor 520 may be implemented in hardware, firmware, or a combination of hardware and software. The processor 520 may include one or more processors capable of being programmed to perform one or more operations or processes described elsewhere herein.

The memory 530 may store information, one or more instructions, and/or software (e.g., one or more software applications) related to the operation of the microgrid controller 110. The memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the microgrid controller 110 to receive input, load information, generator data, energy storage data, status information, scheduling information, and/or control signals (e.g., control signals from a macrogrid controller). The output component 550 may enable the microgrid controller 110 to provide output, such as one or more control signals for controlling loads, energy storage systems, breakers, switches, and other components associated with the microgrid described herein. The communication component 560 may enable the microgrid controller 110 to communicate with other devices via a wired connection and/or a wireless connection. For example, the communication component 560 may include a receiver, a transmitter, and/or a transceiver.

The microgrid controller 110 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. Execution of the set of instructions, by one or more processors 520, may cause the one or more processors 520 and/or the microgrid controller 110 to perform one or more operations or processes described herein. Hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

### INDUSTRIAL APPLICABILITY

A microgrid controller that is configured to control one or more components and/or systems associated with the microgrid, including energy resource systems (e.g., DERs) and/or loads. The microgrid controller may control a state of the microgrid based on one or more conditions being satisfied. Additionally, the microgrid controller may monitor and assess a health of the microgrid. For example, the microgrid controller may monitor one or more operational conditions, detect or predict one or more errors (e.g., faults) of the microgrid, raise one or more alarms based on the detected or predicted errors, and, in some cases, take one or more corrective actions based on the based on the detected or predicted errors. An error may be an error associated with a mode of operation of the microgrid, an error associated with one or more loads of the microgrid, an error associated with one or more DERs of the microgrid, an error associated with one or more components of the microgrid (e.g., power bus, communication interface, inverter, switch, or distribution breaker), or any combination thereof. The microgrid controller may implement a delay between generating soft alarms and hard alarms, giving time for soft faults to clear on their own before being elevated to a hard fault, which may provide a more flexible diagnostic scheme for assessing which conditions are critical for corrective action.

What is claimed is:

1. A microgrid controller of a microgrid, comprising:
one or more memories configured to store a health monitoring algorithm;
a communication interface configured to receive load information corresponding to a plurality of loads connected to the microgrid, receive energy resource information corresponding to a plurality of energy resource systems connected to the microgrid, and generate one or more alarms based on the health monitoring algorithm; and
one or more processors, coupled to the one or more memories for executing the health monitoring algorithm, wherein the one or more processors are configured to:
monitor one or more microgrid parameters, according to a soft diagnostic condition, based on at least one of the energy resource information or the load information,
detect a soft trigger event based on the one or more microgrid parameters satisfying the soft diagnostic condition,
in response to the soft diagnostic condition being satisfied, monitor the one or more microgrid parameters, according to a hard diagnostic condition, based on at least one of the energy resource information or the load information,
detect a hard trigger event based on the one or more microgrid parameters satisfying the hard diagnostic condition, and
in response to the hard diagnostic condition being satisfied, generate a hard alarm.

2. The microgrid controller of claim 1, wherein the one or more processors are configured to, in response to the soft diagnostic condition being satisfied, generate a soft alarm.

3. The microgrid controller of claim 1, wherein the soft diagnostic condition is a fixed setpoint condition,
wherein the hard diagnostic condition is a dynamic setpoint condition, and
wherein the one or more processors are configured to adjust the hard diagnostic condition as a function of an operational activity of the microgrid.

4. The microgrid controller of claim 3, wherein the one or more processors are configured to adjust the hard diagnostic condition based on a rate-of-change of a microgrid parameter of the one or more microgrid parameters or based a magnitude of the microgrid parameter.

5. The microgrid controller of claim 3, wherein the one or more processors are configured to adjust the hard diagnostic condition based on a real-time load rate-of-change.

6. The microgrid controller of claim 3, wherein the hard diagnostic condition includes a dynamic threshold, and
the one or more processors are configured to adjust the dynamic threshold as a function of the operational activity of the microgrid.

7. The microgrid controller of claim 1, wherein the soft diagnostic condition includes at least one of a value-based threshold or a time-based threshold.

8. The microgrid controller of claim 1, wherein the plurality of energy resource systems includes a fuel-based energy resource system,
wherein the one or more microgrid parameters include an operation mode of the fuel-based energy resource system, including an inactive operation mode and a running operation mode, during which the fuel-based energy resource system generates power,
wherein the soft diagnostic condition is satisfied based on the fuel-based energy resource system failing to transition from the inactive operation mode to the running operation mode within a first time duration that starts at a time a start command is issued to the fuel-based energy resource system, and
wherein the hard diagnostic condition is satisfied based on the fuel-based energy resource system failing to transition from the inactive operation mode to the running operation mode within a second time duration that starts at a time the soft diagnostic condition is satisfied.

9. The microgrid controller of claim 8, wherein the plurality of energy resource systems includes a chargeable energy storage system, and
wherein the one or more processors are configured to:
monitor a state-of-charge (SOC) of the chargeable energy storage system,
compare the SOC to a minimum SOC threshold, and
issue the start command to the fuel-based energy resource system based on the SOC being less than the minimum SOC threshold.

10. The microgrid controller of claim 1, wherein the one or more microgrid parameters include an operation mode of an energy resource system, including a first operation mode, during which the energy resource system does not supply power to the microgrid, and a second operation mode, during which the energy resource system supplies power to the microgrid,
wherein the soft diagnostic condition is satisfied based on the energy resource system failing to transition between the first operation mode and the second operation mode within a first time duration that starts at a time a mode command is issued to the energy resource system, and
wherein the hard diagnostic condition is satisfied based on the energy resource system failing to transition between the first operation mode and the second operation mode within a second time duration that starts at a time the soft diagnostic condition is satisfied.

11. The microgrid controller of claim 1, wherein the plurality of energy resource systems includes one or more chargeable energy storage systems, and
wherein the one or more processors are configured to:
monitor a state-of-charge (SOC) of the one or more chargeable energy storage systems, and
monitor a total load on the microgrid, the total load being cumulative of the plurality of loads,
wherein the soft diagnostic condition is satisfied based on the SOC being less than an SOC threshold, and
wherein the hard diagnostic condition is satisfied based on the SOC decreasing for a time duration during which the total load is increasing, the time duration starting at a time the soft diagnostic condition is satisfied.

12. The microgrid controller of claim 1, wherein the plurality of energy resource systems includes one or more chargeable energy storage systems, and
wherein the one or more processors are configured to:
monitor a state-of-charge (SOC) of the one or more chargeable energy storage systems, and
monitor a total load on the microgrid, the total load being cumulative of the plurality of loads,
wherein the soft diagnostic condition is satisfied based on the SOC decreasing, for a first time duration, while the total load is increasing, and
wherein the hard diagnostic condition is satisfied based on the SOC decreasing, for a second time duration that starts at a time the soft diagnostic condition is satisfied, while the total load is increasing.

13. The microgrid controller of claim 1, wherein the plurality of energy resource systems includes one or more chargeable energy storage systems, and
wherein the one or more processors are configured to:
monitor a state-of-charge (SOC) of the one or more chargeable energy storage systems, and
monitor a total load on the microgrid, the total load being cumulative of the plurality of loads,
wherein the soft diagnostic condition is satisfied based on the SOC being less than an SOC threshold, and
wherein the hard diagnostic condition is satisfied based on the SOC decreasing for a time duration that starts at a time the soft diagnostic condition is satisfied.

14. The microgrid controller of claim 1, wherein the plurality of energy resource systems includes one or more chargeable energy storage systems, and
wherein the one or more processors are configured to:
monitor a state-of-charge (SOC) of the one or more chargeable energy storage systems, and
monitor a total load on the microgrid, the total load being cumulative of the plurality of loads,
wherein the soft diagnostic condition is satisfied based on the SOC being less than a first SOC threshold, and
wherein the hard diagnostic condition is satisfied based on the SOC being less than a second SOC threshold while the total load is increasing, the second SOC threshold being less than the first SOC threshold.

15. The microgrid controller of claim 1, wherein the one or more processors are configured to:
monitor an output power of one or more energy resource systems based on a target output power,
wherein the soft diagnostic condition is satisfied based on the output power being less than the target output power for a first time duration, and
wherein the hard diagnostic condition is satisfied based on the output power being less than the target output power for a second time duration that starts at a time the soft diagnostic condition is satisfied.

16. The microgrid controller of claim 1, wherein the plurality of energy resource systems includes a chargeable energy storage system and a generator system configured to generate power from a power source, and
wherein the one or more processors are configured to:
dispatch power from the generator system to charge the chargeable energy storage system, and
monitor an amount of power provided by the generator system to the chargeable energy storage system relative to a target amount of power,
wherein the soft diagnostic condition is satisfied based on the amount of power being less than the target amount of power for a first time duration, and
wherein the hard diagnostic condition is satisfied based on the amount of power being less than the target amount of power for a second time duration that starts at a time the soft diagnostic condition is satisfied.

17. The microgrid controller of claim 1, wherein the one or more processors are configured to:
monitor an output power of one or more energy resource systems based on a target output power,
wherein the soft diagnostic condition is satisfied based on the output power changing by at least a threshold amount a first threshold number of times within a first time interval, and
wherein the hard diagnostic condition is satisfied based on the output power changing by at least the threshold amount a second threshold number of times within a second time interval.

18. The microgrid controller of claim 1, wherein the one or more processors are configured to:
monitor an amount of power imported from a macrogrid relative to a target import power,
wherein the soft diagnostic condition is satisfied based on the amount of power being less than the target import power for a first time duration or being less than the target import power by at least a first threshold amount,
wherein the hard diagnostic condition is satisfied based on the amount of power being less than the target import power for a second time duration or being less than the target import power by at least a second threshold amount,
wherein the second time duration starts at a time the soft diagnostic condition is satisfied, and
wherein the second threshold amount is greater than the first threshold amount.

19. The microgrid controller of claim 18, wherein the amount of power is real power or reactive power.

20. A method of monitoring for errors within a microgrid, the method comprising:
receiving, by a microgrid controller, energy resource information corresponding to a plurality of energy resource systems associated with the microgrid;
receiving, by the microgrid controller, load information corresponding to a plurality of loads associated with the microgrid;
monitoring, by the microgrid controller, one or more microgrid parameters, according to a soft diagnostic condition, based on at least one of the energy resource information or the load information;
detecting, by the microgrid controller, a soft trigger event based on the one or more microgrid parameters satisfying the soft diagnostic condition;
in response to the soft diagnostic condition being satisfied, monitoring, by the microgrid controller, the one or more microgrid parameters, according to a hard diagnostic condition, based on at least one of the energy resource information or the load information;
detecting, by the microgrid controller, a hard trigger event based on the one or more microgrid parameters satisfying the hard diagnostic condition; and
in response to the hard diagnostic condition being satisfied, generating, by the microgrid controller, a hard alarm.
